(19) United States
(12) Patent Application Publication
(10) Pub. No.: US 2014/0274713 A1
(43) Pub. Date: Sep. 18, 2014

(54) IONIC LIQUIDS AND USES THEREOF

(71) Applicant: OMS Investments, Inc., Los Angeles, CA (US)

(72) Inventors: Carlos BARRIENTOS, Dublin, OH (US); Jennifer Fisher, Hilliard, OH (US); Robert D. Baker, Westerville, OH (US)

(73) Assignee: OMS Investments, Inc., Los Angeles, CA (US)

(21) Appl. No.: 14/212,664

(22) Filed: Mar. 14, 2014

Related U.S. Application Data
(60) Provisional application No. 61/787,693, filed on Mar. 15, 2013.

(51) Int. Cl. A01N 37/38; C05G 3/02

(52) U.S. Cl. CPC A01N 37/38; C05G 3/02
USPC 504/145

(57) ABSTRACT

Embodiments of the present invention relate to compositions comprising fatty acid or fatty amine salt of a first herbicidal agent, in which a second herbicidal agent is dissolved to form a solution of the second herbicidal agent and the fatty acid or fatty amine salt of the first herbicidal agent. The resulting solution is useful in the preparation of products coated therewith.

### FIELD OF THE INVENTION

Embodiments of the present invention relate to compositions comprising a fatty acid salt or a fatty amine salt of a first herbicidal agent, in which a second herbicidal agent is dissolved to form a solution of the second herbicidal agent and the fatty acid salt or fatty amine salt of the first herbicidal agent. The resulting solution is useful in the preparation of products coated therewith.

### BACKGROUND OF THE INVENTION

Methods are known for improving the distribution of agriculturally active ingredients (e.g., herbicides) on the surface of granules. See, e.g., Published U.S. Application No. 2009/0093368, which is incorporated by reference in its entirety. Some of these methods involve preparing sprayable liquid solutions of at least one agriculturally active ingredient and applying the solutions on granules by spraying. Such methods provide a coating on the surface of the granules that enables substantially all of the agriculturally active ingredient on the granule to be solubilized by the naturally occurring moisture present on the foliage of a treated weed. Although these methods are highly efficient and produce coated granules with highly desirable characteristics, they sometimes involve melting the agriculturally active ingredients at high temperature and spraying the molten agriculturally active ingredients onto granules. Some of the drawbacks associated with melting the agriculturally active ingredients include the generation of strong odors and high energy usage.

### SUMMARY OF THE INVENTION

The embodiments of the present invention overcome such drawbacks by using fatty acid salts of agriculturally active ingredients. These fatty acid salts melt at much lower temperatures (e.g., 50° C.) and, when melted, can effectively act as a solvent for another agriculturally active ingredient. The resulting solution can be sprayed on granules without the need for high temperatures and without generating strong odors.

In one embodiment, the invention relates to a composition comprising a first herbicidal agent, or a salt thereof, dissolved in a second herbicidal agent, wherein the second herbicidal agent is in the form of a fatty acid salt or fatty amine salt of the second herbicidal agent.

In another embodiment, the invention relates to a composition comprising a fatty acid salt or fatty amine salt of a first herbicidal agent and a second herbicidal agent dissolved in the first herbicidal agent.

In still another embodiment, the invention relates to a composition comprising a solution of a first herbicidal agent, or a salt thereof, and a second herbicidal agent, wherein the second herbicidal agent is in the form of a fatty acid salt or fatty amine salt of the second herbicidal agent.

In another embodiment, the invention relates to a granule coated with a composition comprising a first herbicidal agent, or a salt thereof, dissolved in a second herbicidal agent, wherein the second herbicidal agent is in the form of a fatty acid salt or fatty amine salt of the second herbicidal agent.

Other objects and advantages will become apparent to those skilled in the art from a consideration of the ensuing detailed descriptions set forth herein.

### BRIEF DESCRIPTION OF THE DRAWINGS

FIG. 1 is a melt curve for the oleyl amine salt of the herbicide 2,4-dichlorophenoxyacetic acid, also known as 2,4-D.

FIG. 2 is a graph showing the stability of a 4.6% AE oleyl amine salt of MSM in different temperature chambers.

### DETAILED DESCRIPTION OF THE PREFERRED EMBODIMENTS

The foregoing and other aspects of the present invention will now be described in more detail with respect to embodiments described herein. It should be appreciated that the invention can be embodied in different forms and should not be construed as limited to the embodiments set forth herein. Rather, these embodiments are provided so that this disclosure will convey the scope of the invention to those skilled in the art.

In one embodiment, the invention relates to a composition comprising a first herbicidal agent, or a salt thereof, dissolved in a second herbicidal agent, wherein the second herbicidal agent is in the form of a fatty acid salt or fatty amine salt of the second herbicidal agent. In some embodiments, the compositions can comprise one or more additional herbicidal agents (i.e., in addition to the first and second herbicidal agents) or salts thereof. In some embodiments, the one or more additional herbicidal agents can be in the free acid or free base form of the agents. In other embodiments, the one or more additional herbicidal agents can be in the form of a fatty acid salt or fatty amine salt.

In another embodiment, the invention relates to a composition comprising a fatty acid salt or fatty amine salt of a first herbicidal agent and a second herbicidal agent dissolved in the first herbicidal agent.

In still another embodiment, the invention relates to a composition comprising a solution of a first herbicidal agent, or a salt thereof, and a second herbicidal agent, wherein the second herbicidal agent is in the form of a fatty acid salt or fatty amine salt of the second herbicidal agent.

As used herein, the term “fatty acid salt” of the herbicidal agent refers to the salt formed, whether completely or partially, between a fatty acid salt and the herbicidal agent, where the herbicidal agent is capable of deprotonating the fatty acid salt to form the conjugate base of the fatty acid salt (i.e., the fatty acid carboxylate). Exemplary, but non-limiting fatty acids include C₁₄-C₂₂, e.g., C₁₄-C₂₀, C₁₄-C₁₈ or C₁₈-C₂₂, saturated or unsaturated fatty acids. Exemplary, but non-limiting C₁₄-C₂₂ fatty acids include myristic acid, palmitic acid, stearic acid, arachidic acid, behenic acid, myristoleic acid, plamitoleic acid, sapienic acid, oleic acid, elaidic acid, vaccenic acid, linoleic acid, linoelaidic acid, a-linoleic acid, arachidonic acid, eicosapentaenoic acid, and erucic acid. The fatty acid salt may be either the first herbicidal agent or the second herbicidal agent.

As used herein, the term “fatty amine salt” of the herbicidal agent refers to the salt formed, whether completely or partially, between a fatty amine salt and the herbicidal agent, where the herbicidal agent is capable of protonating the fatty amine salt to form the conjugate acid of the fatty amine salt (i.e., the fatty ammonium salt). Exemplary, but non-limiting fatty amine salts include C₁₄-C₂₂, e.g., C₁₄-C₂₀, C₁₄-C₁₈ or C₁₈-C₂₂, saturated or unsaturated fatty amine salts. Exemplary, but non-limiting C₁₄-C₂₂ fatty amine salts include myristyl amine, palmityl amine, stearyl amine, arachidyl amine, behenyl amine, myristoleyl amine, plamitoleyl amine, sapienyl amine, oleyl amine, elaidyl amine, vaccenyl amine, linoleyl amine, linoelaidyl amine, a-linoleyl amine, arachidonyl amine, eicosapentaenoyl amine, and erucyl amine The fatty amine salt may be either the first herbicidal agent or the second herbicidal agent.

As used herein, the term “herbicidal agent” means, without limitation, herbicides that are sufficiently acidic or sufficiently basic, such that they are able to form a fatty acid salt with a fatty amine salt or a fatty acid, respectively.

In some embodiments, the herbicidal agents contemplated herein fall into several classes of compounds including, but not limited to amide herbicides (e.g., amicarbazone, benzadox, cafenstrole, cuprazole, epronaz, fentrazamide, flucarbazone, flupoxam, huangcaoling, isoxaben, diflufenican, flufenacet, flufenican, ipfencarbazone, mefenacet, metamifop, picolinafen, sulfentrazone, triafamone, benzoylprop, flamprop, diathatyl, metazachlor, cloransulam, diclosulam, florasulam, flumetsulam, pyrimisulfan, asulam, oryzaline, penoxsulam, pyroxsulam, and bencarbazone); aromatic acid herbicides (e.g., choramben, dicamba, 2,3,6-TBA, tricamba, bispyribac, pyriminobac, pyrithiobac, chlorthal, aminopyralid, clopyralid, picloram, quinclorac, and quinmerac); arsenical herbicides (e.g., MAA, MAMA, and MSMA); benzothiazole herbicides (e.g., benazolin and fenthiaprop); dicarboximide herbicides (e.g., flumiclorac); dinitroaniline herbicides (e.g., chlornidine, dinitramine, dipropalin, ethaflurin, fluchloralin, isopropalin, methalpropalin, nitralin, pendimethalin, prodiamine, profluralin, and trifluralin); diphenyl ether herbicides (e.g., acifluorfen, aclonifen, fluoroglycofen, alorac, chloropon, dalapon, flupropanate, hexachloroacetone, monochloroacetic acid, and TCA); imidazolinone herbicides (e.g., imazamethabenz, imazamox, imazapic, imazapyr, imazaquin, and imazethapyr); organophosphorus herbicides (e.g., bilanafos, fosamine, glufosinate, and glyphosate); oxazole herbicides (e.g., topramezone); phenoxy herbicides (e.g., 2-methyl-4-chlorophenoxyacetic acid (a.k.a., MCPA), methylchlorophenoxy propionic acid (a.k.a., MCPP), 2,4-dichlorophenoxyacetic acid (a.k.a., 2,4-D); difenopenten, disul, 4-CPA, 3,4-DA, MCPA-thioethyl, 2,4,5-T, 4-CPB, 2,4-DB, 3,4-DB, MCPB, 2,4,5-TB, cloprop, 4-CPP, dichlorprop, 3,4-DP, fenoprop, mecoprop, chlorazifop, clodinafop, clofop, cyhalofop, diclofop, fenoxaprop, fenthiaprop, fluazifop, haloxyfop, kuicaoxy, propaquizafop, quizalofop, and trifop); phenylenediamine herbicides (e.g., dinitramine and prodiamine); pyrazole herbicides (e.g., azimsulfuron, halosulfuron, metazachlor, metazosulfuron, pyrazosulfuron, pyroxasulfone, benzofenap, pyrasulfotole, pyrazolynate, pyrazoxyfen, topramezone, fluazolate, nipyraclofen, and pyraflufen); pyridazine herbicides (e.g., credazine, pyridafol, and pyridate); pyridazinone herbicides (e.g., brompyrazone, chloridazin, dimidazon, flufenpyr, metflurazon, norflurazon, oxapyrazon, and pydanon); pyridine herbicides (e.g., aminopyralid, cliodinate, clopyralid, diflufenican, dithiopyr, flufenican, fluroxypyr, haloxydine, picloram, picolinafen, pyriclor, pyroxsulam, thiazopyr, and triclopyr); pyrimidinediamine herbicides (e.g., iprymidam and tioclorim); pyrimidinyloxybenzylamine herbicides (e.g., pyribambenz-isopropyl and pyribambenz-propyl); thiocarbamate herbicides (e.g., pyributicarb); thiourea herbicides (e.g., methiuron); triazine herbicides (e.g., dipropetry, fucaojing, trihydroxytriazine, atrazine, chlorazine, cyanazine, cyprazine, eglinazine, ipazine, mesoprazine, procyazine, proglinazine, propazine, sebuthylazine, simazine, terbuthylazine, trietazine, indaziflam, triaziflam, atraton, methometon, prometon, secbumeton, simeton, terbumeton, ametryn, aziprotryne, cyanatryn, desmetryn, dimethametryn, methoprotryne, prometryn, simetryn, and terbutryn); triazinone herbicides (e.g., ametridione, amibuzin, ethiozin, hexazinone, isomethiozin, metamitron, and metribuzin); triazole herbicides (e.g., amitrole, cafenstrole, epronaz, and flupoxam); triazolone herbicides (e.g., carfentrazone, propoxycarbazone, and thiencarbazone); triazolopyrimidine herbicides (e.g., metosulam); uracil herbicides; urea herbicides (e.g., thidiazuron); sulfonylurea herbicides (e.g., amidosulfuron, bensulfuron, chlorimuron, cyclosulfamuron, ethoxysulfuron, flazasulfuron, flucetosulfuron, flupyrsulfuron, foramsulfuron, imazosulfuron, mesosulfuron, methiopyrisulfuron, monosulfuron, nicosulfuron, orthosulfamuron, oxasulfuron, primisulfuron, propyrisulfuron, pyrazosulfuron, rimsulfuron, sulfometuron, sulfosulfuron, trifloxysulfuron, zuomihuanglong, chlorsulfuron, cinosulfuron, ethametsulfuron, iodosulfuron, iofensulfuron, metsulfuron (a.k.a., methsulfuron methyl or MSM), prosulfuron, thifensulfuron, triasulfuron, tribenuron, triflusulfuron, tritosulfuron, buthiuron, ethidimuron, tebuthiuron, thiazafluron, and diazuron) and combinations thereof. See www.alanwood.net/pesticides/classherbicides.html, which is incorporated by reference in its entirety herein.

In some embodiments, the herbicidal agents contemplated herein include the following unclassified herbicides: aminocyclopyrachlor, azafenidin, bentranil, bicyclopyrone, buthidazole, cambendichlor, chorfenac, chlorfenprop, chlorflurazole, chlorflurenol, CPMF, endothal, fluoromidine, fluridone, flurtamone, fluthiacet, pelargonic acid, pyrosulfalin, pyribenzoxim, pyriftalid, quinoclamine, rhodenthanil, and sulglycapin).

The herbicides contemplated herein may possess one or more asymmetric centers. Such compounds can therefore be produced as individual (R)- or (S)-stereoisomers or as mixtures thereof. Unless indicated otherwise, the description or naming of a particular herbicides in the specification and claims is intended to include both individual enantiomers and mixtures, racemic or otherwise, thereof.

In some embodiments, the first herbicidal agent is a phenoxy herbicide, including 2-methyl-4-chlorophenoxyacetic acid, methylchlorophenoxy propionic acid, 2,4-dichlorophenoxyacetic acid or salts thereof or mixtures thereof. In some embodiments, the phenoxy herbicide is a solid at room temperature. In all other embodiments, the phenoxy herbicide is a liquid at room temperature. In some embodiments the phenoxy herbicide is 2,4-D. In another embodiment, the 2,4-D is a solid at room temperature. In still another embodiment, the 2,4-D is a liquid at room temperature.

In other embodiments, the second herbicidal agent is a phenoxy herbicide, including 2-methyl-4-chlorophenoxyacetic acid, methylchlorophenoxy propionic acid, 2,4-dichlorophenoxyacetic acid or salts thereof or mixtures thereof. In some embodiments, the phenoxy herbicide is a solid at room temperature. In all other embodiments, the phenoxy herbicide is a liquid at room temperature. In some embodiments the phenoxy herbicide is 2,4-D. In another embodiment, the 2,4-D is a solid at room temperature. In still another embodiment, the 2,4-D is a liquid at room temperature.

In some embodiments, the first herbicidal agent is 2,4-dichlorophenoxyacetic acid and the second herbicidal agent is 2,4-dichlorophenoxyacetic acid. In other embodiments, the first herbicidal agent is 2,4-dichlorophenoxyacetic acid and the second herbicidal agent is methylchlorophenoxy propionic acid. In still other embodiments, the first herbicidal agent is 2,4-dichlorophenoxyacetic acid and the second herbicidal agent is 2-methyl-4-chlorophenoxyacetic acid. In other embodiments, the first herbicidal agent is 2-methyl-4-chlorophenoxyacetic acid and the second herbicidal agent is methylchlorophenoxy propionic acid. In still other embodiments, the first herbicidal agent is methylchlorophenoxy propionic acid and the second herbicidal agent is 2-methyl-4-chlorophenoxyacetic acid.

In other embodiments, the first herbicidal agent is 2,4-dichlorophenoxyacetic acid and the second herbicidal agent is a mixture of two or more phenoxy herbicides. The mixture of two or more phenoxy herbicides includes a mixture of two or more of 2-methyl-4-chlorophenoxyacetic acid, methylchlorophenoxy propionic acid, 2,4-dichlorophenoxyacetic acid or salts thereof.

In some embodiments, the first herbicidal agent is 2,4-dichlorophenoxyacetic acid and the second herbicidal agent is a fatty amine salt. The ratio of 2,4-D to fatty amine salt may be, without limitation, 1:1, 2:1, 3:1, 4:1, 1:2, 1:3, or 1:4. In other embodiments, the first herbicidal agent is a fatty amine salt and the second herbicidal agent is 2,4-dichlorophenoxyacetic acid. The ratio of the fatty amine salt to 2,4-D may be, without limitation, 1:1, 2:1, 3:1, 4:1, 1:2, 1:3, or 1:4. In another embodiment, the first herbicidal agent is 2,4-dichlorophenoxyacetic acid and the second herbicidal agent is a fatty acid salt. The ratio of 2,4-D to fatty acid salt may be, without limitation, 1:1, 2:1, 3:1, 4:1, 1:2, 1:3, or 1:4. In still another embodiment, the first herbicidal agent is a fatty acid salt and the second herbicidal agent is 2,4-dichlorophenoxyacetic acid. The ratio of the fatty acid salt to 2,4-D may be, without limitation, 1:1, 2:1, 3:1, 4:1, 1:2, 1:3, or 1:4.

In some embodiments the first herbicidal agent is a sulfonylurea herbicide including, without limitation, methylsulfuron methyl (MSM); pyrimidinylsulfonylurea herbicides including amidosulfuron, azimsulfuron, bensulfuron, chlorimuron, cyclosulfamuron, ethoxysulfuron, flazasulfuron, flucetosulfuron, flupyrsulfuron, foramsulfuron, halosulfuron, imazosulfuron, mesosulfuron, metazosulfuron, methiopyrisulfuron, monosulfuron, nicosulfuron, orthosulfamuron, oxasulfuron, primisulfuron, propyrisulfuron, pyrazosulfuron, rimsulfuron, sulfometuron, sulfosulfuron, trifloxysulfuron, and zuomihuanglong; and triazinylsulfonylurea herbicides including chlorsulfuron, cinosulfuron, ethametsulfuron, iodosulfuron, iofensulfuron, metsulfuron, prosulfuron, thifensulfuron, triasulfuron, tribenuron, triflusulfuron, and tritosulfuron; or combinations thereof.

The compositions of some of the embodiments of the present invention comprising a first herbicidal agent, or a salt thereof, dissolved in a second herbicidal agent, wherein the second herbicidal agent is in the form of a fatty acid salt or fatty amine salt of the second herbicidal agent may be solids or liquids at room temperature (e.g., at 25° C.). In some embodiments, the compositions are liquid at room temperature. In other embodiments, the compositions are solid at room temperature.

In some embodiments, the second herbicidal agent, which is in the form of a fatty acid salt or fatty amine salt of the second herbicidal agent, may be a solid or a liquid at room temperature. In some embodiments, the second herbicidal agent is a liquid at room temperature. In other embodiments, the second herbicidal agent is a solid at room temperature. In still other embodiments, the second herbicidal agent is a liquid at about 45° C. In some embodiments, the second herbicidal agent melts at about 50° C. Higher concentrations of the herbicidal agents have a tendency to be more viscous. Thus, in one embodiment, a broad fan spray is desirable to provide an even coating on the granules. In another embodiment, the solution is heated to a temperature at least of at least about 88° C. As an example, a 2.75% spray volume solution, comprising 22% AE MCPP-p and 44% AE 2,4-D ionic liquid, requires a temperature of about 88° C. to about 93° C. to achieve the same spray patterns as 3.5% spray volume of an ionic solution comprising 17.5% MCPP-p and 34.5% AE 2,4-D at a temperature of about 71° C.

Those of skill in the art will recognize that the compositions of the embodiments of the present invention may be made by dissolving the first herbicidal agent, or a salt thereof, in the second herbicidal agent or by dissolving the second herbicidal agent in the first herbicidal agent, or a salt thereof.

Some embodiments of the present invention are directed to a granule coated with a composition comprising a first herbicidal agent, or a salt thereof, dissolved in a second herbicidal agent, wherein the second herbicidal agent is in the form of a fatty acid salt or fatty amine salt of the second herbicidal agent. The granule may be inert or it may be a fertilizer granule. Exemplary inert granule materials include, but are not limited to corncobs, peanut hulls, processed paper pulp, sawdust, agglomerated cellulosic carrier granules, wood fiber core granules, compressed coir granules, processed paper pulp, limestone, gypsum, sand, vermiculite, perlite, fuller's earth and clays (e.g., attapulgite clays, bentonite clays, and montmorillonite clays). In one embodiment, the inert granules may comprise characteristics that allow for it to be more absorbent. For example, granules containing a processed paper pulp (e.g., biodac) have shown to absorb a higher liquid loading than dolmitc limestone. In another embodiment, the inert granules may comprise additives that may enhance the biological function of the granules. For example, the granules may include an agglomeration of dispersed particles or fines that have the property of increased hardness or crush resitance as described in PCT/US12/32596. Such granules are well known to a person of ordinary skill in the art. Exemplary fertilizer granules include, but are not limited to, fertilizer granules comprising potassium nitrate, potassium sulfate, urea, ammonium nitrate, monopotassium sulfate, ammonium phosphate; fertilizers containing micronutrients or trace elements; and urea formaldehyde fertilizers (e.g., disclosed in U.S. Pat. Nos. 6,039,781 and 6,579,831 incorporated by reference herein). In one embodiment, fertilizer granules advantageously act as a time-released capsule allowing nutrients to flow out over time.

In some embodiments, the granules coated with a composition comprising a first herbicidal agent, or a salt thereof, dissolved in a second herbicidal agent, wherein the second herbicidal agent is in the form of a fatty acid salt or fatty amine salt of the second herbicidal agent include molten urea reaction process (MURP)-based fertilizer granules and/or granules formed from dispersed particles or fines as described in PCT/US12/32596.

In some embodiments, the invention relates to a method for controlling undesired vegetation (e.g., weeds) comprising applying granules coated with a composition comprising a first herbicidal agent, or a salt thereof, dissolved in a second herbicidal agent, wherein the second herbicidal agent is in the form of a fatty acid salt or fatty amine salt of the second herbicidal agent to an area in need thereof. In preferred embodiments, the granules are coated with the composition so that the composition, as a whole, delivers a herbicidally effective amount of the first and/or second herbicidal agents. In some embodiments, a “herbicidally effective amount” of the first and/or second herbicidal agents is about 0.0001 to 20 kg/ha, e.g., 0.001 to 5 kg/ha or 0.004 to 3 kg/ha. Determining the herbicidally effective amount necessary for the desired level of weed control may be readily done by one of skill in the art.

In some embodiments, the compositions comprising a first herbicidal agent, or a salt thereof, dissolved in a second herbicidal agent, wherein the second herbicidal agent is in the form of a fatty acid salt or fatty amine salt of the second herbicidal agent may further comprise a solvent and/or a surfactant. Exemplary solvents include, but are not limited to ethylene glycol monomethyl ether, ethylene glycol monoethyl ether, ethylene glycol monopropyl ether, ethylene glycol monobutyl ether, ethylene glycol inonomethyl ether acetate, ethylene glycol monoethyl ether acetate, ethylene glycol rnonohexyl ether, ethylene glycol mono-2-ethylhexyl ether, ethylene glycol monophenyl ether, diethylene glycol monomethyl ether, diethylene glycol monoethyl ether, diethylene glycol monopropyl ether, diethylene glycol monobutyl ether, ethylene glycol monobutyl ether acetate, diethylene glycol monoethyl ether acetate, diethylene glycol monobutyl ether acetate, propylene glycol monomethyl ether, propylene glycol monopropyl ether, propylene glycol monobutyl ether, propylene glycol monophenyl ether, dipropylene glycol monomethyl ether, and propylene glycol monomethyl ether acetate. In one embodiment, any surfactant may be used and one of skill may easily determine the types.

In a further embodiment, the invention relates to a composition made by a process comprising:
(a) reacting a second herbicidal agent with a fatty acid salt or a fatty amine salt to produce a product; and
(b) dissolving a first herbicidal agent, or a salt thereof, in the product of step (a).

### EXAMPLES

Having now generally described the invention, the same will be more readily understood by reference to the following examples, which are provided by way of illustration and are not intended as limiting. It is understood that various modifications and changes can be made to the herein disclosed exemplary embodiments without departing from the spirit and scope of the invention.

### Example 1

Solid 2,4-D (30.96 g) was reacted with oleyl amine in a ratio of 1:1 to generate the corresponding 2,4-D oleyl ammonium salt, which then dissolved an additional 33.07 g as an off-white, waxy solid having a melting point of 50° C. The melt curve of the 2,4-D oleyl ammonium salt is shown in FIG. 1.

The 2,4-D oleyl ammonium salt is heated to its melting point of 50° C. To the melted 2,4-D oleyl ammonium salt is added MCPP (24.31 g) to form a dark red viscous liquid at room temperature.

### Example 2

MSM (4.71 g) was reacted with oleyl amine (91.94 g) Dowanol DPM (dipropylene glycol methyl ether) under high shear, given a clear solution of the oleyl amine salt of MSM (4.6% AE MSM solution). This solution was stable at room temperature for three weeks. The stability of the solution was assessed at various temperatures, including room temperature (RT), freeze thaw cycle (F/T), 2° C., 32° C., and 50° C. Over a four week time period, the solution was found to be relatively stable at both room temperature and 2° C. (FIG. 2.). A 2.5% MSM ionic liquid was also prepared using an analogous procedure.

MSM alone did not dissolve in Dowanol DPM under high shear.

### Example 3

A mixer was charged with 24.31 lbs of MURP fertilizer including biodac as an inert compound. While mixing, 311.84 g of 44% AE 2,4-D, 22% AE MCPP-p was sprayed onto the granules. The liquid was heated in a pressure pot to about 88° C. and sprayed through a 6503 nozzle. The granules were allowed to mix for 5 minutes to ensure even coating.

### Example 4

Utilizing the same procedure as set forth in example 3, a mixer is charged with 24.31 lbs of granules as described in PCT/US12/32596 and further includes biodac as an inert compound. While mixing, 311.84 g of 44% AE 2,4-D, 22% AE MCPP-p is sprayed onto the granules. The liquid is heated in a pressure pot to about 88° C. and sprayed through a 6503 nozzle. The granules are allowed to mix for 5 minutes to ensure even coating.

### Example 5

A product of the invention was made according to Example 1. The formulation of the product, 128.014, was applied to three weed species: dandelion (Taraxacum officinale), buckhorn plantain (Plantago lanceolata) and common catsear (Hypochoeris radicata). Additionally, a hot melt formulation, S-13759, was prepared and applied to the same three weed species. These weed species are commonly found in home lawn, and the levels of efficacy are representative of typical results.

The ionic and hot melt formulations were applied by weighing the exact amount required to cover a plot based on a 2.858 lb per 1000 ft² rate. These amounts were applied using a shaker jar or distribution device capable of evenly applying the product. Applications occurred in the morning when dew was present on the surface of weed leaves, or plots were sprayed with water mist to provide surface moisture equivalent to dew. The plots were visually assessed at 28 and 56 days after treatment (DAT) for percent weed control.

Table 1 contains the characteristics of the product applied to the weed and feed products. Table 2 contains the analysis of variance and means separation (Fishers Protected LSD, P=0.05) at 28 and 56 DAT for dandelion control. Table 3 contains results at 28 and 56 DAT for buckhorn plantain and common catsear.

TABLE 1

| | | | | | Herbicide |
|---|---|---|---|---|---|
| | Active | Fertilizer | Herbicide | Produce | Application |
| Formulation # | Ingredients | Analysis | Rate (lb ae/acre) | Rate (lb/1000 ft²) | Method |
| 128.014 | 1.21% 2,4-D | 29-0-4 | 2,4-D = 1.5 | 2.858 | Ionic |
| | 0.61% MCPP-p | | MCPP-p = 0.75 | | solution |
| S-13759 | 1.21% 2,4-D | 28-1-4 | 2,4-D = 1.5 | 2.858 | Hot melt |
| | 0.61% MCPP-p | | MCPP-p = 0.75 | | |

TABLE 2

| | M-12-L-W- | C- | |
|---|---|---|---|
| Product | 108-02-DSH | 12-L-W-117-OSU-02 | M-12-L-W-198-01-DSH |
| | Dandelion Control at 28 DAT (0-100%) | | |
| 128.014 | 25.7* | 93.7 | 50.1 |
| S-13759 | 8.3 | 84.8 | 46.3 |
| | Dandelion Control at 56 DAT (0-100%) | | |
| 128.014 | 50.9* | 81.3 | 59.0 |
| S-13759 | 12.0 | 73.1 | 41.6 |

*denotes a statistically significant difference in percent weed control.

TABLE 3

| | M-12-L-W-194-04-DSH | G-12-L-W-158-02-JLM |
|---|---|---|
| Product | Buckhorn plantain | Common catsear |
| | Weed Control at 28 DAT (0-100%) | |
| 128.014 | 73.3* | 32.3 |
| S-13759 | 19.9 | 31.6 |

Weed Control at 56 DAT (0-100%)

| | | |
|---|---|---|
| 128.014 | 81.8* | 29.4 |
| S-13759 | 13.7 | 26.3 |

*denotes a statistically significant difference in percent weed control.

Table 2 shows a comparison at 28 DAT and 56 DAT of percentage dandelion control for three different species of dandelion (M-12-L-W-108-02-DSH, C-12-L-W-117-OSU-02, and M-12-L-W-198-01-DSH). Percent weed control following application of claimed ionic solution (128.014) was higher compared to the hot melt formulation (S-13759). For example, at 28 DAT the claimed formulation was effective at controlling 25.7% dandelion growth compared to 8.3% dandelion control using the hot melt formulation on dandelion species M-12-L-W-108-02-DSH.

Similarly, Table 3 shows a comparison at 28 DAT and 56 DAT of percentage weed control for buckhorn plantain and common catsear weeds. Percent weed control following application of claimed ionic solution (128.014) was again higher compared to the hot melt formulation (S-13759). For example, at 28 DAT the claimed formulation was effective at controlling 73.3% buckhorn plantain growth compared to 19.9% buckhorn plantain control using the hot melt formulation.

In every trial, percent weed control following application of 128.014 (ionic solution) was higher compared to S-13759 (hot melt). Therefore, the 128.014 (ionic solution) provided increased efficacy (percent weed control) compared to S-13759 (hot melt).

It is to be understood that the above-described compositions and modes of application are only illustrative of preferred embodiments of the present invention. Numerous modifications and alternative arrangements may be devised by those skilled in the art without departing from the spirit and scope of the present invention. The appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function and manner of operation, assembly and use may be made without departing from the principles and concepts set forth herein.

Patents, patent applications, publications, product descriptions, and protocols cited throughout this application are incorporated herein by reference in their entireties for all purposes.

We claim:

1. A composition comprising a first herbicidal agent, or a salt thereof, dissolved in a second herbicidal agent, wherein the second herbicidal agent is in the form of a fatty acid salt or fatty amine salt of the second herbicidal agent.

2. The composition of claim 1, wherein the second herbicidal agent forms a liquid at about 45° C.

3. The composition of claim 1, wherein the second herbicidal agent is a solid at room temperature.

4. The composition of claim 1, wherein the second herbicidal agent is a liquid at room temperature.

5. The composition of claim 1, wherein the first herbicidal agent is 2-methyl-4-chlorophenoxyacetic acid, methylchlorophenoxy propionic acid, 2,4-dichlorophenoxyacetic acid or salts thereof or mixtures thereof.

6. The composition of claim 1, wherein the second herbicidal agent is 2-methyl-4-chlorophenoxyacetic acid, methylchlorophenoxy propionic acid, 2,4-dichlorophenoxyacetic acid, salts thereof, or mixtures thereof.

7. The composition of claim 1, wherein the fatty amine salt of the second herbicidal agent is the C₁₄-C₂₂ fatty amine salt of the second herbicidal agent.

8. The composition of claim 7, wherein the C₁₄-C₂₂ fatty amine salt of the second herbicidal agent is the oleyl ammonium salt of the second herbidical agent.

9. The composition of claim 8, wherein the second herbicidal agent is 2,4-dichlorophenoxyacetic acid.

10. The composition of claim 7, wherein the C₁₄-C₂₂ fatty amine salt comprises one or more unsaturations.

11. The composition of claim 1, wherein the fatty acid salt of the second herbicidal agent is the C₁₄-C₂₂ fatty acid of the second herbicidal agent.

12. The composition of claim 11, wherein the C₁₄-C₂₂ fatty acid salt comprises one or more unsaturations.

13. A method of making the composition of claim 1 comprising dissolving a first herbicidal agent, or a salt thereof, in the second herbicidal agent.

14. A method of making the composition of claim 1 comprising dissolving the second herbicidal agent in the first herbicidal agent, or a salt thereof.

15. A granule coated with a composition comprising a first herbicidal agent, or a salt thereof, dissolved in a second herbicidal agent, wherein the second herbicidal agent is in the form of a fatty acid salt or fatty amine salt of the second herbicidal agent.

16. A method for controlling weeds comprising applying the granule of claim 15 to an area in need thereof.

17. The granule of claim 15, wherein the granule is a fertilizer granule.

18. The granule of claim 17, wherein the fertilizer is a molten urea reaction process-based fertilizer.

19. A composition made by a process comprising:
(a) reacting a second herbicidal agent with a fatty acid or a fatty amine to produce a product; and
(b) dissolving a first herbicidal agent, or a salt thereof, in the product of step (a).
